(19) United States
(12) Patent Application Publication
(10) Pub. No.: US 2026/0252674 A1
(43) Pub. Date: Aug. 27, 2026

(54) INFORMATION PROCESSING APPARATUS, INFORMATION PROCESSING METHOD, AND PROGRAM

(71) Applicant: Sony Group Corporation, Tokyo (JP)

(72) Inventors: Hiroto YAMADA, Saitama (JP); Yasushi MINOYA, Tokyo (JP)

(73) Assignee: Sony Group Corporation, Tokyo (JP)

(21) Appl. No.: 19/160,348

(22) PCT Filed: Feb. 5, 2024
(86) PCT No.: PCT/JP2024/003772

§ 371 Date: Aug. 27, 2025

(30) Foreign Application Priority Data
Mar. 27, 2023 (JP) 2023-049991

(51) Int. Cl. G06F 21/32; G06F 3/01

(52) U.S. Cl. CPC G06F 21/32; G06F 3/011

(57) ABSTRACT

[Object]

A user of a terminal that logs in to a virtual space is determined to be the user him/herself at higher accuracy.

[Solving Means]

Provided is an information processing apparatus including a communication section that receives, when logging in to a virtual space is requested by a terminal used by a user, registered information that is requested in the virtual space and that includes that biometric information of the user corresponding to the virtual space is registered in the terminal, and a permitting section that permits the terminal to log in to the virtual space, in reference to the registered information received by the communication section.

[Selected Drawing] FIG. 3

### TECHNICAL FIELD

The present disclosure relates to an information processing apparatus, an information processing method, and a program.

### BACKGROUND ART

A technology of using information of a user in a virtual space is under development these days. For example, PTL 1 discloses a technology of, when a terminal used by a user logs in to a different virtual space from a virtual space to which the terminal is logged in, forwarding information of the user from a server that manages the virtual space to a server that manages the different virtual space. Here, the information of the user includes ID (Identification) information such as a user name and a password, character information, and the like.

### CITATION LIST

### Patent Document

### PTL 1

Japanese Patent Laid-open No. 2001-325616

### SUMMARY

### Technical Problem

However, permitting the terminal to log in to a different virtual space based on the information of the user as described in PTL 1 makes it difficult to determine whether the user of the terminal that logs in to the different virtual space is the relevant user him/herself or not.

In light of the abovementioned circumstance, a new and improved information processing apparatus, information processing method, and program that are capable of highly accurately determining that the user of the terminal that has logged in to the virtual space is the relevant user him/herself are proposed.

### Solution to Problem

According to an aspect of the present disclosure, there is provided an information processing apparatus including a communication section that receives, when logging in to a virtual space is requested by a terminal used by a user, registered information that is requested in the virtual space and that includes that biometric information of the user corresponding to the virtual space is registered in the terminal, and a permitting section that permits the terminal to log in to the virtual space, in reference to the registered information received by the communication section.

Further, according to another aspect of the present disclosure, there is provided an information processing method executed by a computer, including receiving, when logging in to a virtual space is requested by a terminal used by a user, registered information that is requested in the virtual space and that includes that biometric information of the user corresponding to the virtual space is registered in the terminal, and permitting the terminal to log in to the virtual space, in reference to the registered information received.

Further, according to yet another aspect of the present disclosure, there is provided a program that causes a computer to implement a communication function of receiving, when logging in to a virtual space is requested by a terminal used by a user, registered information that is requested in the virtual space and that includes that biometric information of the user corresponding to the virtual space is registered in the terminal, and a permitting function of permitting the terminal to log in to the virtual space, in reference to the registered information received.

### BRIEF DESCRIPTION OF DRAWINGS

FIG. 1 is an explanatory diagram for explaining an outline of an information processing system according to the present disclosure.

FIG. 2 is an explanatory diagram for explaining an example of a functional configuration of an edge terminal 10 according to the present disclosure.

FIG. 3 is an explanatory diagram for explaining an example of a functional configuration of a server 20 according to the present disclosure.

FIG. 4A is a view illustrating an example of multiple virtual spaces managed by multiple servers 20.

FIG. 4B is a view illustrating another example of multiple virtual spaces managed by multiple servers 20.

FIG. 5 is a sequence diagram illustrating an example of a flow of logging in to a world related to the information processing system according to the present disclosure.

FIG. 6 is a sequence diagram illustrating an example of a flow of world movement related to an information processing system according to a first embodiment.

FIG. 7 is a sequence diagram illustrating an example of a flow of world movement related to an information processing system according to a second embodiment.

FIG. 8 is a sequence diagram illustrating an example of a flow of world movement related to an information processing system according to a third embodiment.

FIG. 9 is an explanatory diagram for explaining a specific example of content and virtual objects that serve as a trigger for world movement.

FIG. 10 is an explanatory diagram for explaining another example of virtual objects that serve as a trigger for world movement.

FIG. 11 is an explanatory diagram for explaining an example of operation processing in the server 20 according to the present disclosure.

FIG. 12 is a block diagram illustrating a hardware configuration example of an information processing apparatus 90 according to one embodiment of the present disclosure.

### DESCRIPTION OF EMBODIMENTS

Preferred embodiments of the present disclosure are described in detail below with reference to the attached drawings. Note that, in the present specification and drawings, components having substantially the same functional configuration are denoted by the same reference signs to omit redundant description.

Note that the description is given in the following order.
1. Outline of information processing system
2. Example of functional configuration
   2.1. Example of functional configuration of edge terminal 10
   2.2. Example of functional configuration of server 20
3. Details
   3.1. Logging in to world
   3.2. Moving from world to different world
   3.3. UI example related to world movement
4. Example of operation processing
5. Example of hardware configuration
6. Supplement

### 1. Outline of Information Processing System

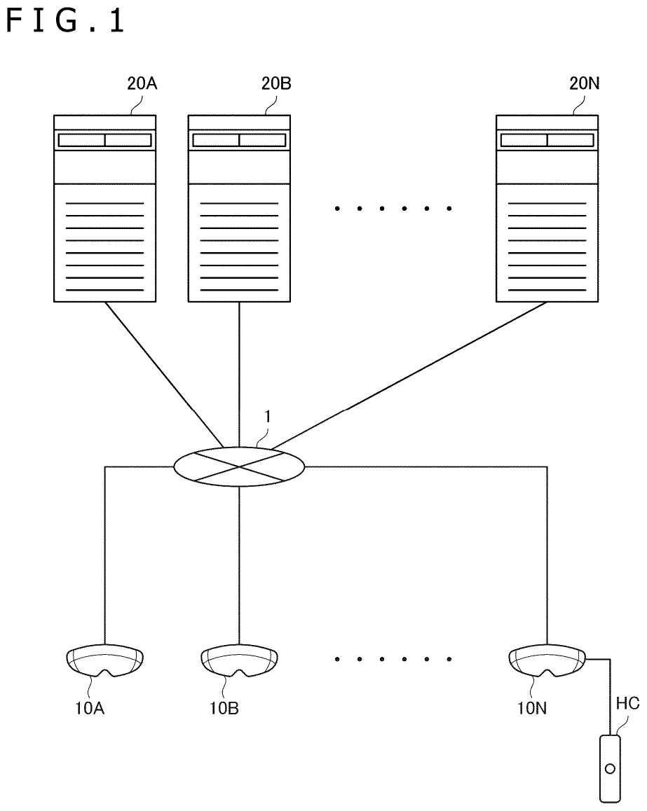

FIG. 1 is an explanatory diagram for explaining an outline of an information processing system according to the present disclosure. The information processing system according to the present disclosure includes, as illustrated in FIG. 1, a network 1, multiple edge terminals 10A through 10N, and multiple servers 20A through 20N.

### Network 1

The network 1 is a wired or wireless transmission channel for information that is transmitted from a device connected to the network 1. For example, the network 1 may include a public network such as the Internet, a telephone network, or a satellite communication network, various types of LANS (Local Area Networks) including Ethernet (registered trademark), a WAN (Wide Area Network), and the like. Further, the network 1 may include a leased line network such as an IP-VPN (Internet Protocol-Virtual Private Network).

Each of the multiple edge terminals 10A through 10N and each of the multiple servers 20A through 20N are connected to one another via the network 1.

### Edge Terminal 10

The edge terminal 10 according to the present disclosure is a terminal used by a user. The edge terminal 10 is, for example, implemented by an HMD (Head mounted Display), an eyeglass-type display device such as an AR (Augmented Reality) glasses, a smartphone, a tablet terminal, a PC (Personal Computer), or the like.

For example, the edge terminal 10 logs in to any of the multiple virtual spaces by a user operation. Further, the edge terminal 10 can move from a virtual space to which the edge terminal 10 is logged in to a different virtual space by a user operation. Nore that, in the present disclosure, for the sake of description, movement of a virtual camera that captures images to be provided to the edge terminal 10 of the user from a virtual space to a different virtual space is expressed, for example, as “the edge terminal 10 moves from a virtual space to a different virtual space” or “the user moves from a virtual space to a different virtual space.”

Moreover, the edge terminal 10 is locked (restricted from being used) such that any person who is not the user as the owner of the edge terminal 10 cannot use the edge terminal 10. Further, the edge terminal 10 can be unlocked by use of information of the user. For example, the edge terminal 10 is unlocked by biometric authentication (for example, face authentication) with use of biometric information of the user.

More specifically, assuming that the edge terminal 10 is an HMD, performing biometric authentication every time the HMD is worn makes is possible to confirm that the person wearing the HMD is the user him/herself.

Note that a case where the edge terminal 10 is used by multiple users (for example, family members and the like) can also be assumed. In this case, the edge terminal 10 may determine the user wearing the edge terminal 10, in reference to the biometric information acquired when being worn.

Further, in the edge terminal 10, biometric information of the user is registered. For example, the user may, before logging in to the virtual space, register his/her own biometric information in the edge terminal 10 in advance. Specific examples of the biometric information to be registered in the edge terminal 10 are described later.

Further, the edge terminal 10 transmits, to the relevant server 20, registered information that is requested in a virtual space and that includes that the biometric information of the user according to the relevant virtual space is registered in the edge terminal 10, when the edge terminal 10 logs in to the virtual space.

Further, the edge terminal 10 receives, from the server 20, permission information indicating that logging in to the virtual space is permitted. When the permission information is received from the server 20, the edge terminal 10 is able to log in to the virtual space.

Further, the edge terminal 10 may be connected to a connection device HC as the edge terminal 10N illustrated in FIG. 1. The connection device HC here includes, for example, various kinds of devices such as a hand controller, a mouse, a keyboard, a smartphone, or a tablet terminal.

### Server 20

The server 20 according to the present disclosure is an example of an information processing apparatus and is a device that manages a virtual space. For example, the multiple servers 20A through 20N each manage virtual spaces different from one another.

The server 20 receives, from the edge terminal 10, the registered information that is requested in a virtual space and that includes that the biometric information of the user corresponding to the virtual space is registered in the relevant edge terminal 10, when the edge terminal 10 logs in to the virtual space.

Further, the server 20 permits the edge terminal 10 to log in to the virtual space, in reference to the registered information received from the edge terminal 10. Further, upon permitting the edge terminal 10 to log in to the virtual space, the server 20 transmits permission information indicating that logging in to the virtual space is permitted to the edge terminal 10.

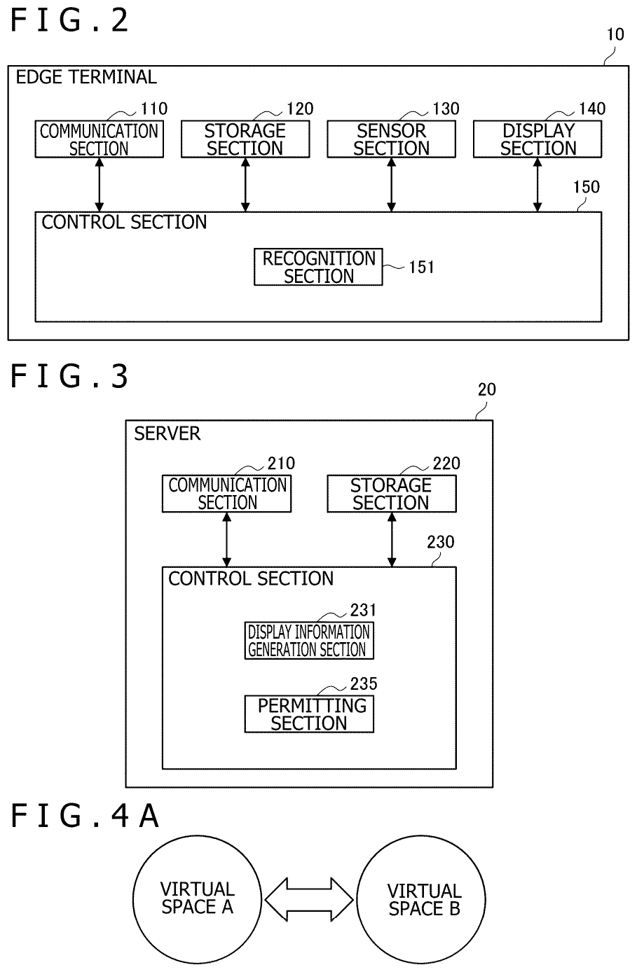

The outline of the information processing system according to the present disclosure has been described above. Next, an example of a functional configuration of each of the edge terminal 10 and the server 20 according to the present disclosure is described with reference to FIGS. 2 through 4.

### 2. Example of Functional Configuration

### 2.1. Example of Functional Configuration of Edge terminal 10

FIG. 2 is an explanatory diagram for explaining an example of the functional configuration of the edge terminal 10 according to the present disclosure. The edge terminal 10 according to the present disclosure includes, as illustrated in FIG. 2, a communication section 110, a storage section 120, a sensor section 130, a display section 140, and a control section 150.

### Communication Section 110

The communication section 110 according to the present disclosure performs various kinds of communication with the server 20. For example, the communication section 110 may transmit, to the server 20, the registered information that is requested in a virtual space to which the edge terminal 10 logs in and that includes that the biometric information of the user corresponding to the virtual space is registered in the storage section 120.

For example, the communication section 110 transmits, to the server 20, log-in request information requesting logging in to the virtual space managed by the server 20. Next, the communication section 110 receives, from the server 20, biometric registration request information for requesting whether or not the biometric information requested in the virtual space with respect to which the edge terminal 10 has requested logging in is registered in the storage section 120. Further, the communication section 110 may transmit, to the server 20, the registered information based on the biometric registration request information received from the server 20.

Further, the communication section 110 may receive, in a case where the edge terminal 10 is connected to the connection device HC illustrated in FIG. 1, various kinds of sensing information from the connection device HC.

Storage Section 120

The storage section 120 according to the present disclosure holds software and various kinds of data. For example, the storage section 120 may hold biometric information of the user. Further, the storage section 120 may hold behavioral information of the user.

For example, the storage section 120 may hold the biometric information or behavioral information that is requested by each of the multiple virtual spaces. The user may register, in the edge terminal 10, his/her own biometric information or behavioral information before the edge terminal 10 logs in to the virtual space or register, in the edge terminal 10 as appropriate, the biometric information or behavioral information requested at the time of logging in to the virtual space.

### Sensor Section 130

The sensor section 130 according to the present disclosure is a device for acquiring various kinds of sensing information. For example, the sensor section 130 may be implemented by various kinds of sensor devices including a microphone, a camera, a piezoelectric sensor, or a fingerprint sensor. Further, the edge terminal 10 may include both an internal camera for imaging the user side and an external camera for imaging the user's line of sight side, as an example of the sensor section 130. Further, the camera may be an RGB camera or a Depth camera.

### Display Section 140

The display section 140 according to the present disclosure displays various kinds of images in the virtual space. For example, the display section 140 may display a display screen in the virtual space. Further, the display section 140 may display various kinds of content, virtual objects, or the like used for moving between multiple virtual spaces. Specifically, the display section 140 may display the display screen in the virtual space in reference to the display information received from the server 20. Specific examples of the display screen displayed by the display section 140 according to the present disclosure are described later.

### Control Section 150

The control section 150 according to the present disclosure controls the overall operations of the edge terminal 10. The control section 150 includes, as illustrated in FIG. 2, a recognition section 151.

The recognition section 151 recognizes the biometric information of the user using the edge terminal 10. For example, the recognition section 151 may recognize the biometric information of the user in reference to various kinds of sensing information acquired by the sensor section 130 or the communication section 110.

Specifically, the recognition section 151 may recognize such biometric information as respiration, a voiceprint, or contents of speech (for example, a text chat, a voice chat, or the like) in reference to the sensing information acquired by a microphone.

Further, the recognition section 151 may recognize such biometric information as a fingerprint, a heartbeat, a pulse, a body temperature, a brain wave, blood pressure, a force sensation, or a grip strength in reference to the sensing information acquired by a sensor device.

Further, the recognition section 151 may recognize such biometric information as a fingerprint, a vein, an iris, a face, an auricle, a heartbeat, a pulse, eye blinking, or gaze information (for example, a line of sight, a gaze, a focus, or a convergence angle for both eyes) in reference to the sensing information obtained by a camera.

Further, the recognition section 151 may register the recognized biometric information in the storage section 120 in reference to the various kinds of sensing information.

Further, the recognition section 151 may recognize behavioral information in reference to the sensing information acquired by the sensor section 130 or the communication section 110.

Specifically, the recognition section 151 may recognize such behavioral information as a gyro rotation amount, an angular velocity, a SLAM (Simultaneous Localization and Mapping) or 6DoF (Degrees of Freedom) movement amount, or an amount of waving in reference to the sensing information obtained by the connection device HC (for example, a hand controller, a tablet terminal, or the like) illustrated in FIG. 1, for example. Further, the recognition section 151 may register the recognized behavioral information in the storage section 120.

One example of the functional configuration of the edge terminal 10 according to the present disclosure has been described above. Next, an example of the functional configuration of the server 20 according to the present disclosure is described with reference to FIG. 3.

### 2.2. Example of Functional Configuration of Server 20

FIG. 3 is an explanatory diagram for explaining an example of the functional configuration of the server 20 according to the present disclosure. The server 20 according to the present disclosure includes, as illustrated in FIG. 3, a communication section 210, a storage section 220, and a control section 230.

### Communication Section 210

The communication section 210 according to the present disclosure performs various kinds of communication with the edge terminal 10. For example, the communication section 210 receives, from the edge terminal 10, the registered information that is requested in the virtual space to which the edge terminal 10 logs in and that includes that the biometric information of the user corresponding to the virtual space is registered in the storage section 120.

Further, the communication section 210 may receive, from the edge terminal 10, the registered information that is requested in a different virtual space and that includes that the biometric information of the user corresponding to the different virtual space is registered in the storage section 120, when the edge terminal 10 moves to the different virtual space. Further, the communication section 210 may transmit (transfer) the registered information received from the edge terminal 10 to a different server 20 that manages the different virtual space.

Further, the communication section 210 may transmit, to the edge terminal 10, permission information indicating that logging in to the virtual space is permitted, when the edge terminal 10 is permitted to log in to the virtual space by a permitting section 235 that is to be described later.

### Storage Section 220

The storage section 220 according to the present disclosure holds software and various kinds of data. For example, the storage section 220 holds various kinds of information regarding multiple virtual spaces, use information of the user, or such information as the avatar and the digital items of the user. For example, the storage section 220 holds information related to the registered information which the edge terminal 10 is requested in the virtual space managed by the server 20.

Further, the storage section 220 may hold the information related to the registered information which the edge terminal 10 is requested in a different virtual space managed by a different server 20.

Note that, for each of the multiple virtual spaces according to the present disclosure, a multiverse environment in which virtual spaces are linked to one another can be assumed. For example, the virtual space managed by the server 20 and the different virtual space managed by the different server 20 can differ in the degree of linkage.

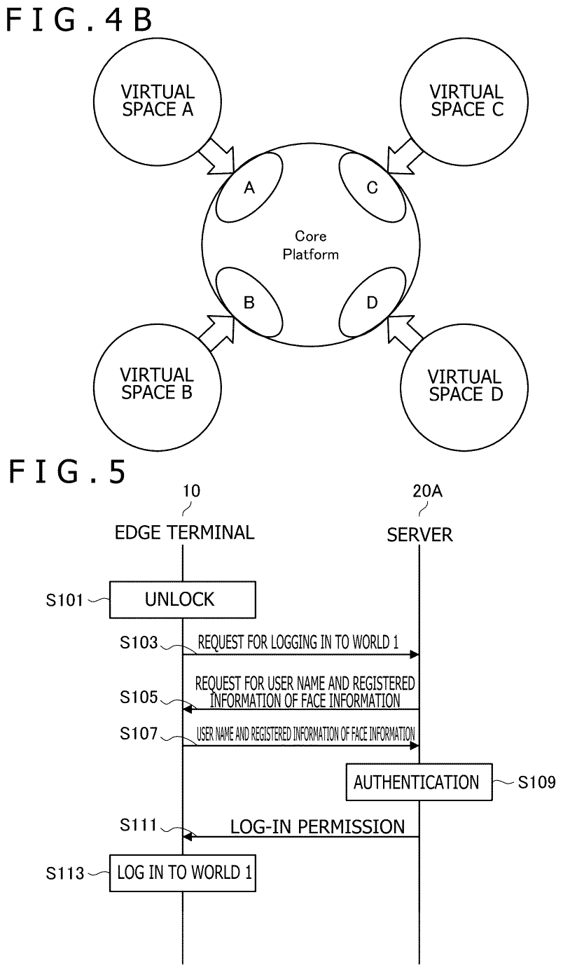

Accordingly, the storage section 220 may hold information related to the registered information which the edge terminal 10 is requested in a different virtual space which has a high degree of linkage with the virtual space managed by the server 20. On the other hand, the storage section 220 may not hold information related to the registered information requested in a different virtual space which has a low degree of linkage with the virtual space managed by the server 20. In the following description, specific examples of multiple virtual spaces managed by multiple servers 20 are explained with reference to FIGS. 4A and 4B.

FIGS. 4A and 4B are each a view illustrating an example of multiple virtual spaces managed by multiple servers 20. According to the example illustrated in FIG. 4A, a first server 20 may manage a virtual space A (metaverse A), while a second server 20 may manage a virtual space B (metaverse B). In the manner described above, the multiple servers 20 may manage the multiple virtual spaces (multiverse) by an interoperated system in which an independent virtual space (metaverse A) and an independent virtual space B (metaverse B) are linked to each other. Such a system realizes independence of each virtual space but allows avatars or digital items to intercommunicate between the two virtual spaces.

Further, according to the example illustrated in FIG. 4B, the first server 20 may manage the virtual space A (metaverse A), the second server 20 may manage the virtual space B (metaverse B), a third server 20 may manage a virtual space C (metaverse C), and a fourth server 20 may manage a virtual space D (metaverse D). In the manner described above, the multiple servers 20 may manage the multiple virtual spaces (multiverse) by a concentrated system in which the virtual space A (metaverse A), the virtual space B (metaverse B), the virtual space C (metaverse C), and the virtual space D (metaverse D) are concentrated in a core platform. Such a system allows services to be concentrated in the core platform and secures interoperation of avatars, digital items, and the like in the platform.

According to the multiple virtual spaces that are linked to one another as described above, for example, the edge terminal 10 can move from one virtual space to a different virtual space. Further, such data as an avatar or a digital item in the virtual space may also be subject to coordination. For example, in a case where coordination of data (for example, avatars, digital items, and the like) is made among multiple virtual spaces and a user moves from one virtual space to a different virtual space, data may also be passed to the different virtual space.

### Control Section 230

The control section 230 according to the present disclosure controls overall operations of the server 20. For example, the control section 230 may execute an authentication process in reference to the registered information of the biometric information of the user received from the edge terminal 10 or a different server 20 that manages a different virtual space. The control section 230 includes a display information generation section 231 and the permitting section 235, as illustrated in FIG. 3.

The display information generation section 231 according to the present disclosure generates display information in the virtual space. For example, the display information generation section 231 generates display information regarding various kinds of content, virtual objects, or the like in the virtual space.

The permitting section 235 according to the present disclosure permits the edge terminal 10 to log in to the virtual space managed by the server 20, in reference to the registered information acquired from the edge terminal 10 or a different server 20 that manages a different world.

One example of the functional configuration of the server 20 according to the present disclosure has been described above. Next, details of the information processing system according to the present disclosure are described with reference to FIGS. 5 through 10. First, a flow of the edge terminal 10 according to the present disclosure logging in to a virtual space is described with reference to FIG. 5. In the following description, the virtual space is sometimes expressed as the world. Moreover, in the following description, explanation is given assuming a case where the edge terminal 10 is an HMD, but as already described above, the edge terminal 10 is not limited to an HMD.

### 3. Details

### 3.1. Logging in to World

FIG. 5 is a sequence diagram illustrating an example of a flow of logging into a world related to the information processing system according to the present disclosure. In addition, the server 20A is a server that manages world 1. Further, in FIG. 5, an example in which the registered information which the edge terminal 10 is requested in the world 1 is the registered information of “face information” is described.

First, the edge terminal 10 acquires the biometric information of the user by being worn by the user and then unlocks by biometric authentication (S101).

Next, the edge terminal 10 transmits, to the server 20A, log-in request information requesting logging in to the world 1 managed by the server 20A, by a user operation (S103).

Subsequently, the server 20A that has received the log-in request information transmits information requesting a user name and the registered information of face information to the edge terminal 10 (S105).

Thereafter, the edge terminal 10 transmits, to the server 20A, the user name of the user using the edge terminal 10 and the registered information including that the face information of the user is registered in the edge terminal 10 (more specifically, the storage section 120).

Then, the server 20A executes the authentication process in reference to the registered information of the face information received from the edge terminal 10 and permits the edge terminal 10 to log in to the world 1 (S109).

Next, the server 20A transmits, to the edge terminal 10, permission information indicating that the edge terminal 10 is permitted to log in to the world 1 (S111).

Subsequently, the edge terminal 10 which has acquired the permission information logs in to the world 1 (S113), and the operation processing related to logging in to the world in the information processing system is ended.

According to the authentication process described above, the server 20A can permit the edge terminal 10 to log in to the world managed by the server 20A, based on the registration of the biometric information of the user according to the world managed by the server 20A in the edge terminal 10. This can improve the level of security compared to authentication using IDs and passwords, since the personal information (biometric information) of the user is registered in the edge terminal 10 in this method. Moreover, since the user would not be authenticated by the server 20 side unless the user himself/herself is wearing the edge terminal 10, the user of the edge terminal 10 that logs in to the world can be determined to be the relevant user him/herself at higher accuracy.

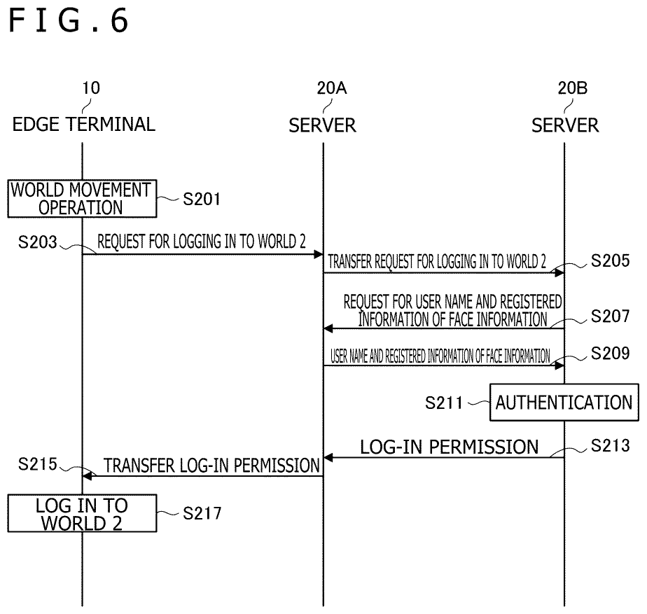

Next, a specific example of a flow in which the edge terminal 10 moves from the world 1 to a different world (world 2, world 3, and world 4) is described with reference to FIGS. 6 through 8. In addition, in first through third embodiments illustrated below, the flow to be followed after the edge terminal 10 has logged in to the world 1 is illustrated.

### 3.1. Moving from World to Different World

### First Embodiment

FIG. 6 is a sequence diagram illustrating an example of a flow of world movement related to the information processing system according to the first embodiment. The server 20A is a server that manages the world 1. The server 20B is a server that manages the world 2. Further, in FIG. 6, an example in which the registered information which the edge terminal 10 is requested in the world 1 is the registered information of the “face information” and the registered information which the edge terminal 10 is requested in the world 2 is also the registered information of the “face information” is described.

First, the edge terminal 10 performs a world movement operation for moving from the world 1 to the world 2 (S201). Specific examples of the world movement operation are described later.

Next, the edge terminal 10 transmits, to the server 20A managing the world 1 to which the edge terminal 10 is logged in, log-in request information requesting logging in to the world 2 (S203).

Thereafter, the server 20A transmits (transfers), to the server 20B managing the world 2, the log-in request information received from the edge terminal 10 (S205).

Subsequently, the server 20B transmits, to the server 20A, information requesting the registered information of the face information and the user name of the user using the edge terminal 10 which has transmitted the log-in request information (S207).

Here, the server 20A has acquired the registered information including that the face information is registered in the edge terminal 10, when the edge terminal 10 logged in to the world 1. In such a case, the server 20A transmits, to the server 20B, the user name and the registered information including that the face information is registered in the edge terminal 10 which have been acquired in advance (S209).

Then, the server 20B executes the authentication process in reference to the registered information of the face information received from the server 20A and permits the edge terminal 10 to log in to the world 2 (S211).

Next, the server 20B transmits, to the server 20A, permission information (that is, log-in permission) indicating that the edge terminal 10 is permitted to log in to the world 2 (S213). Note that the server 20B may directly transmit the permission information to the edge terminal 10.

Subsequently, the server 20A transmits (transfers), to the edge terminal 10, the permission information received from the server 20B (S215).

Then, the edge terminal 10 logs in to the world 2 (S217), and the information processing system ends the operation processing related to world movement.

According to the first embodiment described above, the server 20A transmits, to the server 20B to which the edge terminal 10 plans to move, the registered information which has been acquired in advance from the edge terminal 10. This can reduce the user's time and effort and processing time that are attributable to a repeated request made to the edge terminal 10 for the registered information of the biometric information.

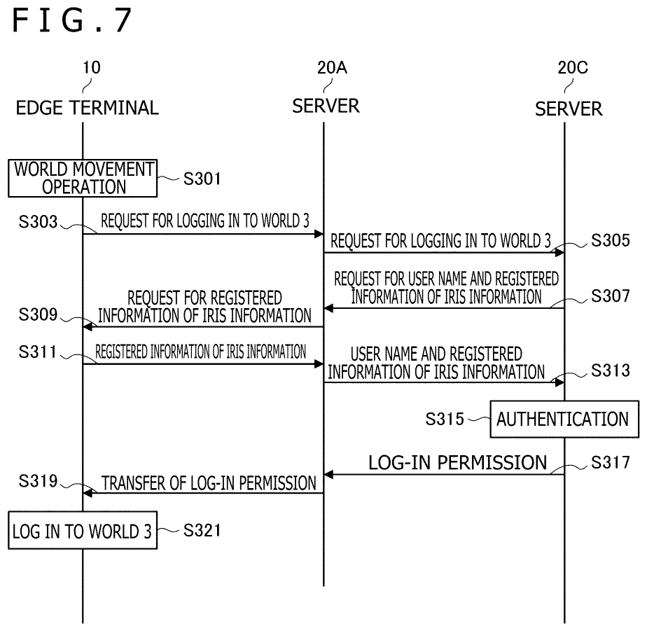

Note that, as described above, a case where there is a high degree of linkage between the world 1 and the world 2 can be assumed. In this case, the server 20A may hold information related to the registered information which the edge terminal 10 is to be requested in the world 2. Specifically, the server 20A may hold information indicating that the registered information which the edge terminal 10 is to be requested in the world 2 is the registered information of the “face information.” In this case, the processes in steps S205 and S207 illustrated in FIG. 7 may be omitted, and the server 20A may, after receiving the log-in request information requesting logging in to the world 2 from the edge terminal 10 (S203), transmit the user name and the registered information of the face information to the server 20B (S209).

### Second Embodiment

FIG. 7 is a sequence diagram illustrating an example of a flow of world movement related to the information processing system according to the second embodiment. The server 20A is a server that manages the world 1. The server 20C is a server that manages the world 3. Further, in FIG. 7, an example in which the registered information which the edge terminal 10 is requested in the world 1 is the registered information of the “face information” and the registered information which the edge terminal 10 is requested in the world 3 is the registered information of “iris information” is described.

First, the edge terminal 10 performs a world movement operation for moving from the world 1 to the world 3 (S301).

Next, the edge terminal 10 transmits, to the server 20A managing the world 1 to which the edge terminal 10 is logged in, log-in request information requesting logging in to the world 3 (S303).

Subsequently, the server 20A transmits (transfers), to the server 20C managing the world 3, the log-in request information received from the edge terminal 10 (S305).

Then, the server 20C transmits, to the server 20A, information requesting the registered information of iris information and the user name of the user using the edge terminal 10 which has transmitted the log-in request information (S307).

Here, the server 20A has acquired the registered information including that the face information is registered in the edge terminal 10, when the edge terminal 10 logged in to the world 1. Meanwhile, the server 20A has not yet acquired the registered information including that the iris information is registered in the edge terminal 10. In such a case, the server 20A transmits, to the edge terminal 10, information requesting the registered information of the iris information (S309).

Next, the edge terminal 10 transmits, to the server 20A, the registered information including that the iris information of the user using the edge terminal 10 is registered in the edge terminal 10 (more specifically, the storage section 120) (S311).

Subsequently, the server 20A transmits, to the server 20C, the user name that has been acquired in advance and the registered information including that the iris information is registered in the edge terminal 10 (S313). At this time, the server 20A may also transmit, to the server 20C, the registered information including that the face information is registered in the edge terminal 10.

Then, the server 20C executes the authentication process in reference to the registered information of the iris information received from the server 20A and permits the edge terminal 10 to log in to the world 3 (S315).

Thereafter, the server 20C transmits, to the server 20A, permission information indicating that the edge terminal 10 is permitted to log in to the world 3 (S317). Note that the server 20C may directly transmit the permission information to the edge terminal 10.

Next, the server 20A transmits (transfers) the permission information received from the server 20C to the edge terminal 10 (S319).

Subsequently, the edge terminal 10 logs in to the world 3 (S319), and the information processing system ends the operation processing related to world movement.

Note that, as described above, a case where there is a high degree of linkage between the world 1 and the world 3 can be assumed. In this case, the server 20A may hold information related to the registered information which the edge terminal 10 is to be requested in the world 3. Specifically, the server 20A may hold information indicating that the registered information which the edge terminal 10 is to be requested in the world 3 is the registered information of the “iris information.” In this case, the processes in steps S305 and S307 illustrated in FIG. 7 may be omitted, and the server 20A may, after receiving the log-in request information requesting logging in to the world 3 from the edge terminal 10 (S303), transmit information requesting the registered information of the iris information to the edge terminal 10 (S309).

### Third Embodiment

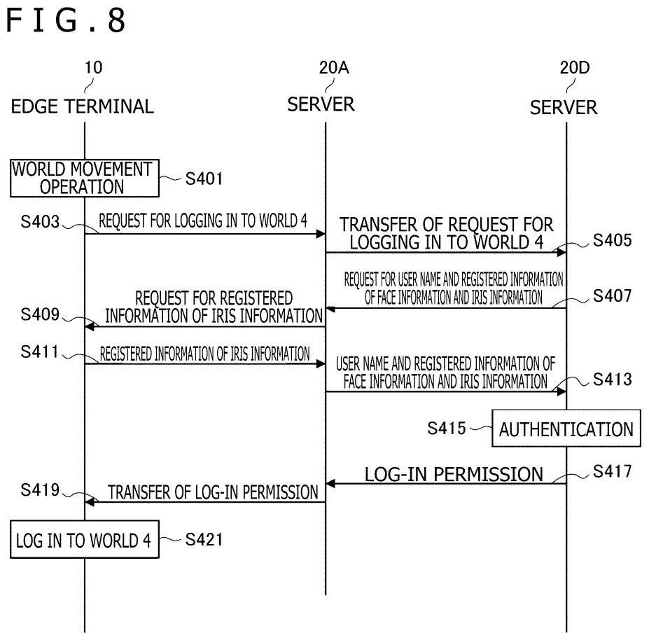

FIG. 8 is a sequence diagram illustrating an example of a flow of world movement related to the information processing system according to the third embodiment. The server 20A is a server that manages the world 1. The server 20D is a server that manages the world 4. Further, further, in FIG. 8, an example in which the registered information which the edge terminal 10 is requested in the world 1 is the registered information of the “face information” and the registered information which the edge terminal 10 is requested in the world 4 is the registered information of the “face information” and “iris information” is described.

First, the edge terminal 10 performs a world movement operation for moving from the world 1 to the world 4 (S401).

Next, the edge terminal 10 transmits, to the server 20A managing the world 1 to which the edge terminal 10 is logged in, log-in request information requesting logging in to the world 4 (S403).

Subsequently, the server 20A transmits (transfers) the log-in request information received from the edge terminal 10 to the server 20D managing the world 4 (S405).

Then, the server 20D transmits, to the server 20A, information requesting the registered information of the face information and iris information and the user name of the user using the edge terminal 10 which has transmitted the log-in request information (S307).

Here, the server 20A has acquired the registered information including that the face information is registered in the edge terminal 10, when the edge terminal 10 logged in to the world 1. Meanwhile, the server 20A has not yet acquired the registered information including that the iris information is registered in the edge terminal 10. In such a case, the server 20A transmits information requesting the registered information of the iris information to the edge terminal 10 (S409). Here, the server 20 may not transmit, to the edge terminal 10, information requesting the registered information of the face information, since the server 20 has acquired in advance the registered information of the face information.

Next, the edge terminal 10 transmits, to the server 20A, the registered information including that the iris information of the user using the edge terminal 10 is registered in the edge terminal 10 (more specifically, the storage section 120) (S411).

Subsequently, the server 20A transmits, to the server 20D, the user name which has been acquired in advance and the registered information including that the face information and the iris information are registered in the edge terminal 10 (S413).

Then, the server 20D executes the authentication process in reference to the registered information of the face information and iris information received from the server 20A and permits the edge terminal 10 to log in to the world 4 (S415).

Thereafter, the server 20D transmits permission information indicating that the edge terminal 10 is permitted to log in to the world 4 to the server 20A (S417). Note that the server 20D may directly transmit the permission information to the edge terminal 10.

Next, the server 20A transmits (transfers) the permission information received from the server 20D to the edge terminal 10 (S419).

Then, the edge terminal 10 logs in to the world 4 (S419), and the operation processing related to world movement in the information processing system is ended.

Note that, as described above, a case where there is a high degree of linkage between the world 1 and the world 4 can be assumed. In this case, the server 20A may hold information related to the registered information which the edge terminal 10 is to be requested in the world 4. Specifically, the server 20A may hold information indicating that the registered information which the edge terminal 10 is to be requested in the world 4 is the registered information of the “face information” and “iris information.” In this case, the processes in steps S405 and S407 illustrated in FIG. 8 may be omitted, and the server 20A may, after receiving the log-in request information requesting logging in to the world 4 from the edge terminal 10 (S403), transmit information requesting the registered information of the iris information to the edge terminal 10 (S409).

As described above, the server 20 transmits the registered information of the biometric information of the user which the server 20 has acquired in advance to a different server 20 that manages a different world, without the edge terminal 10 being involved, but requests the edge terminal 10 for the registered information of the biometric information of the user which the server 20 has not acquired in advance. This reduces the number of times of requesting the edge terminal 10 for the registered information of the biometric information and can reduce the burden related to the world movement of the edge terminal 10.

Note that, in the example described above, a flow of movement of the edge terminal 10 from the world 1 to each of the world 2, the world 3, and the world 4 has been described, but, for example, the edge terminal 10 may first log in to the world 4 that requests the registered information of the face information and iris information. In this case, the edge terminal 10 does not have to additionally transmit the registered information of the biometric information at the time of moving to the world 1 and the world 2 both of which request the registered information of only the face information. Further, the edge terminal 10 also does not have to additionally transmit the registered information of the biometric information at the time of moving to the world 3 that requests the registered information of only the iris information. That is, with the edge terminal 10 first logging in to the world that requests registered information of more items of biometric information, the flow of processes required for movement between worlds is simplified, possibly leading to reduced burden of the edge terminal 10 and the user.

Further, the edge terminal 10 may display an image of the avatar in the world to which the edge terminal 10 plans to move at the time of world movement. For example, when the edge terminal 10 is to move from the world 1 to the world 2 illustrated in FIG. 6, the edge terminal 10 may display the appearance of the avatar in the world 2 on, for example, a virtual object such as a mirror.

Further, the information which the edge terminal 10 is to be requested by a world is not limited to the registered information of the biometric information of the user. For example, the information requested by the world may include the behavioral information of the user. Specifically, in a certain world, the edge terminal 10 may be requested to provide registered information of fingerprint information and behavioral information including the action of waving three times the connection device HC (for example, a hand controller or the like) connected to the edge terminal 10. In this case, the permitting section 235 may permit the edge terminal 10 to log in to the world, when the registered information of the fingerprint information of the user and the behavioral information including the action of waving three times the connection device HC are obtained.

Further, there are indicators that indicate the accuracy of the biometric authentication corresponding to the biometric information. For example, a false acceptance rate (FAR) is known as an indicator that indicates the accuracy of biometric authentication. The false acceptance rate is a rate at which a different person is incorrectly accepted as the relevant person him/herself when authentication is attempted. That is, the higher the false acceptance rate, the more situations where a different person is incorrectly accepted as the relevant person him/herself when authentication is attempted, and the lower the false acceptance rate, the less situations where a different person is incorrectly accepted as the relevant person him/herself when authentication is attempted.

Accordingly, the permitting section 235 according to the present disclosure may permit the edge terminal 10 to log in to the world, based on the false acceptance rate corresponding to the biometric information included in the registered information received from the communication section 210. Note that the value of the false acceptance rate according to each piece of biometric information may refer to publicly known data or may be a value obtained experimentally.

Specifically, in a case where the false acceptance rate of the biometric information included in the registered information requested by the world to which the edge terminal 10 has previously logged in is high (that is, the level of security is low), biometric authentication may be required again in association with world movement.

More specifically, when the false acceptance rate of the registered information requested in the world to which the edge terminal 10 plans to move is high compared to the false acceptance rate of the biometric information included in the registered information requested in the pre-movement world, the biometric authentication according to the world to which the edge terminal 10 plans to move may be requested at the time of world movement.

In contrast, when the false acceptance rate of the registered information requested in the world to which the edge terminal 10 plans to move is low compared to the false acceptance rate of the biometric information included in the registered information requested in the pre-movement world, the biometric authentication may not be required to be performed again at the time of world movement.

For example, the permitting section 235 included in the server 20 that manages the world to which the edge terminal 10 plans to move may, when the false acceptance rate of the biometric information included in the registered information requested in the world managed by the server 20 is equal to or higher than the false acceptance rate of the biometric information included in the registration information requested in the pre-movement world, permit the edge terminal 10 to log in to the world.

Further, the communication section 210 included in the server 20 that manages the world to which the edge terminal 10 has moved may transmit, to the terminal which has been permitted to log in to the world by the permitting section 235, a log-in ticket that allows logging in to a different world that requests the registered information of biometric information the false acceptance rate of which is higher than the false acceptance rate of the biometric information requested in the world.

Providing such a log-in ticket to the edge terminal 10 makes it easier for the edge terminal 10 to move to a world with a security level lower than that of the world to which the edge terminal 10 is logged in, possibly improving the convenience of the user. Note that, for the log-in ticket, such restrictions as an available time (for example, 72 hours) may be imposed.

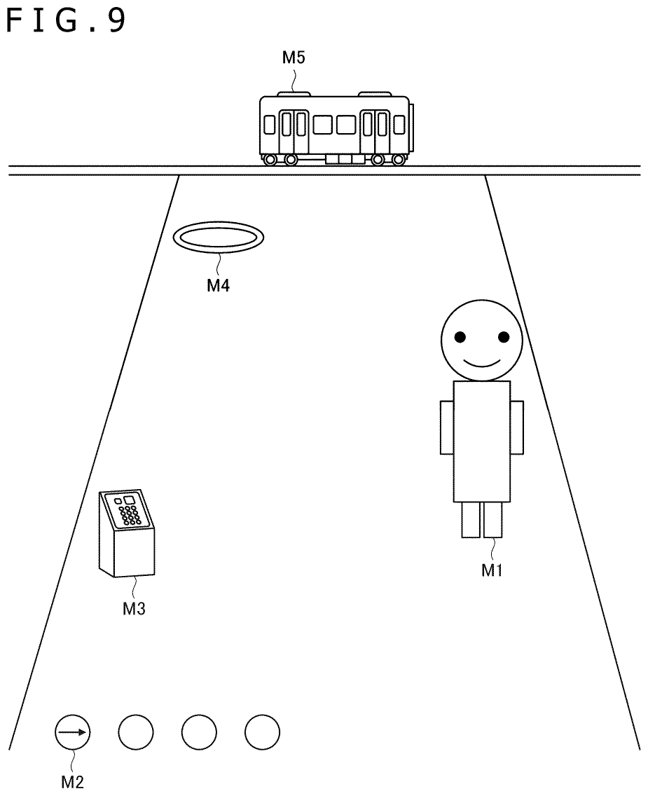

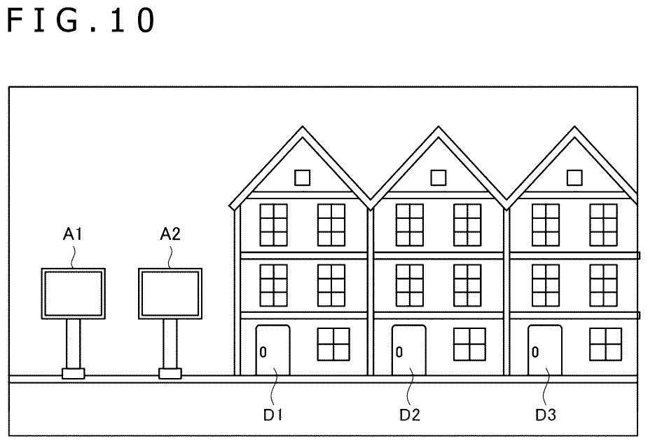

The specific example of the flow of movement of the edge terminal 10 from the world 1 to a different world has been described above. Next, an example of a UI screen related to world movement is described with reference to FIGS. 9 and 10.

### 3.3. UI Example Related to World Movement

As described above, with the user performing a world movement operation, the edge terminal 10 can move to a different world from the world to which the edge terminal 10 is logged in. Here, the request for logging in to a different world (that is, a world movement request) from the world to which the edge terminal 10 is logged in may be based on a user action performed in the world to which the edge terminal 10 is logged in.

For example, each of the worlds managed by each of the respective multiple servers 20 may include content, a virtual object, an area, or the like that serve as a trigger for world movement.

FIG. 9 is an explanatory diagram for explaining a specific example of content, a virtual object, and an area that serve as a trigger for world movement. For example, the edge terminal 10 may transmit log-in request information requesting logging in to a different world to the server 20 that manages the world to which the edge terminal 10 is logged in, based on the user action performed on a specific character M1 present in the world. Note that the specific character M1 is an example of a virtual object.

For example, when the avatar of a user (or a virtual hand of the user in the world, etc.) touches or approaches the specific character M1 present in the world to which the edge terminal 10 is logged in, the edge terminal 10 may display a list including the selection candidates of worlds as the movement destination. Further, the edge terminal 10 may transmit, to the server 20, log-in request information requesting logging in to one world selected by the user.

Further, the edge terminal 10 may transmit the log-in request information requesting logging in to a different world to the server 20 that manages the world to which the edge terminal 10 is logged in, based on a user action performed on a specific button M2 that is present in the world. Note that the specific button M2 is an example of content.

For example, when the virtual hand of the user in the world to which the edge terminal 10 is logged in touches the specific button M2 that is present in the world, the edge terminal 10 may display a list including selection candidates of worlds as the movement destination. Further, the edge terminal 10 may transmit the log-in request information requesting logging in to one world selected by the user to the server 20.

Further, the edge terminal 10 may transmit the log-in request information requesting logging in to a different world to the server 20 that manages the world to which the edge terminal 10 is logged in, based on a user action performed on a specific object M3 that is present in the world. Note that the specific object M3 is an example of a virtual object.

For example, when the avatar of the user (or the virtual hand of the user in the world, etc.) touches the specific object M3 that is present in the world to which the edge terminal 10 is logged in, the edge terminal 10 may display other objects such as a door or a gate.

Further, when the avatar of the user passes the door or the gate, the edge terminal 10 may display a list including the selection candidates of worlds as the movement destination. Alternatively, when the avatar of the user (or the virtual hand of the user in the world, etc.) touches or approaches the door or the gate, the edge terminal 10 may display a list including the selection candidates of worlds as the movement destination. Then, the edge terminal 10 may transmit the log-in request information requesting logging in to one world selected by the user to the server 20.

Further, the edge terminal 10 may transmit the log-in request information requesting logging in to a different world to the server 20 that manages the world to which the edge terminal 10 is logged in, based on a user action performed on a specific area M4 that is present in the world.

For example, when the avatar of the user enters the specific area M4 that is present in the world to which the edge terminal 10 is logged in, the edge terminal 10 may display a list including the selection candidates of worlds as the movement destination. Then, the edge terminal 10 may transmit the log-in request information requesting logging in to one world selected by the user to the server 20.

Alternatively, the edge terminal 10 may transmit the log-in request information requesting logging into a different world to the server 20 that manages the world to which the edge terminal 10 is logged in, based on a user action on a specific vehicle M5 that is present in the world. Note that the specific vehicle M5 is an example of a virtual object.

For example, when the avatar of the user rides the specific vehicle M5 that is present in the world to which the edge terminal 10 is logged in, the edge terminal 10 may display a list including the selection candidates of worlds as the movement destination. Alternatively, when the avatar of the user (or the virtual hand of the user in the world, etc.) touches or approaches the specific vehicle M5, the edge terminal 10 may display a list including the selection candidates of worlds as the movement destination. Then, the edge terminal 10 may transmit the log-in request information requesting logging in to one world selected by the user to the server 20.

Further, in the example illustrated FIG. 9, a train is illustrated as the specific vehicle M5, but an example of the specific vehicle M5 is not limited thereto. For example, the specific vehicle M5 may be an airplane, a ship, a car, or the like.

Further, in the example described above, there has been described an example in which log-in request information is transmitted from the edge terminal 10 to the server 20 by a list including selection candidates of worlds as the movement destination being displayed based on a user action performed on the virtual object, the content, or the area that is present in the world and further one world being selected by the user, but the list including the selection candidates of worlds as the movement destination is not necessarily required to be displayed.

For example, in a case where the number of multiple worlds that are linked to one another is two, the world as the movement destination of the edge terminal 10 would uniformly be decided. Hence, in a case where the number of multiple worlds is two, the edge terminal 10 may, when a user action on a specific virtual object, specific content, or a specific area in the world as described above is obtained, transmit the log-in request information requesting logging in to the other world to the server 20.

Further, the edge terminal 10 may display a virtual object, content, or area corresponding to each of the worlds. Here, with reference to FIG. 10, a specific example of the virtual object corresponding to each of the worlds is described.

FIG. 10 is an explanatory diagram for explaining another example of virtual objects that serve as a trigger for world movement. In FIG. 10, an example in which the world to which the edge terminal 10 is logged in is an initial world is illustrated.

For example, in the initial world, a door D corresponding to each world may be included as illustrated FIG. 10. Specifically, the initial world may include a door DI corresponding to the world 1, a door D2 corresponding to the world 2, and a door D3 corresponding to the world 3.

For example, the edge terminal 10 may, when the avatar of the user enters the door D1 corresponding to the world 1, transmit log-in request information requesting logging in to the world 1 to the server 20 that manages the initial world. Alternatively, when the avatar of the user (or the virtual hand of the user in the initial world, etc.) touches or approaches the door D1 corresponding to the world 1, the edge terminal 10 may transmit the log-in request information requesting logging in to the world 1 to the server 20 that manages the initial world.

Further, the edge terminal 10 may, when the avatar of the user enters the door D2 of the world 2, transmit log-in request information requesting logging in to the world 2 to the server 20 that manages the initial world. Alternatively, when the avatar of the user (or the virtual hand of the user in the initial world, etc.) touches or approaches the door D2 corresponding to the world 2, the edge terminal 10 may transmit the log-in request information requesting logging in to the world 2 to the server 20.

Further, the edge terminal 10 may, when the avatar of the user enters the door D3 corresponding to the world 3, transmit log-in request information requesting logging in to the world 3 to the server 20 that manages the initial world. Alternatively, the edge terminal 10 may, when the avatar of the user (or the virtual hand of the user in the initial world, etc.) touches or approaches the door D3 corresponding to the world 3, transmit the log-in request information requesting logging in to the world 3 to the server 20 that manages the initial world.

Note that the virtual object corresponding to each of the worlds is not limited to a door. For example, the initial world may include a display object A that displays information regarding the inside of each world as illustrated in FIG. 10. Specifically, the initial world may include a display object A1 that displays information regarding the inside of the world 1 and a display object A2 that displays information regarding the inside of the world 2.

For example, the display object A1 may display various kinds of information such as event information of the world 1 or an excitement level (degree representing the excitement of other users regarding an event) in the world 1. Meanwhile, the display object A2 may display various kinds of information such as the event information of the world 2 or the excitement level in the world 2, for example.

Further, the edge terminal 10 may, when the avatar of the user (or the virtual hand of the user in the initial world, etc.) touches or approaches the display object A1, transmit log-in request information requesting logging in to the world 1 to the server 20 that manages the initial world.

Further, the edge terminal 10 may, when the avatar of the user (or the virtual hand of the user in the initial world, etc.) touches or approaches the display object A2, transmit log-in request information requesting logging in to the world 2 to the server 20 that manages the initial world.

Further, the type of the virtual object (for example, the display objects A1 and A2 described above) that is displayed by the edge terminal 10 may differ depending on whether or not the biometric information included in the registered information requested in a different world as the movement destination is included in the biometric information included in the registered information requested in the world to which the edge terminal 10 is logged.

For example, in the example illustrated in FIG. 6, the registered information requested in the world 1 is the registered information of the face information, and the registered information requested in the world 2 is also the registered information of the face information. That is, the biometric information included in the registered information requested in the world 2 is included in the biometric information included in the registered information requested in the world 1.

In such a case, the edge terminal 10 can easily and swiftly make world movement since there is no need to transmit registered information of additional biometric information to the server 20 at the time of moving from the world 1 to the world 2.

Accordingly, the edge terminal 10 may display a virtual object that can allow the user to recognize that more swift movement is possible, as the virtual object for moving from the world 1 to the world 2. A virtual object that can allow the user to recognize that more swift movement is possible may, for example, be a door or a gate. However, the virtual object that can allow the user to recognize that more swift movement is possible is not limited to a door or a gate.

Meanwhile, in the example illustrated in FIG. 7, the registered information requested in the world 1 is the registered information of the face information, and the registered information requested in the world 3 is the registered information of the iris information. That is, the biometric information included in the registered information requested in the world 2 is not included in the biometric information included in the registered information requested in the world 1.

In such a case, the edge terminal 10 needs to transmit the registered information of the additional biometric information to the server 20, at the time of moving from the world 1 to the world 3. That is, in a case of moving from the world 1 to the world 3, a certain amount of time is required compared to the case in which the registered information of the additional biometric information is not transmitted to the server 20.

Hence, the edge terminal 10 may display a virtual object that can allow the user to recognize that a certain amount of time is necessary for world movement, as the virtual object for moving from the world 1 to the world 3. The object that can allow the user to recognize that a certain amount of time is necessary for world movement may, for example, be a vehicle (for example, an airplane, a train, or the like). However, the object that can allow the user to recognize that a certain amount of time is necessary for world movement is not limited to a vehicle.

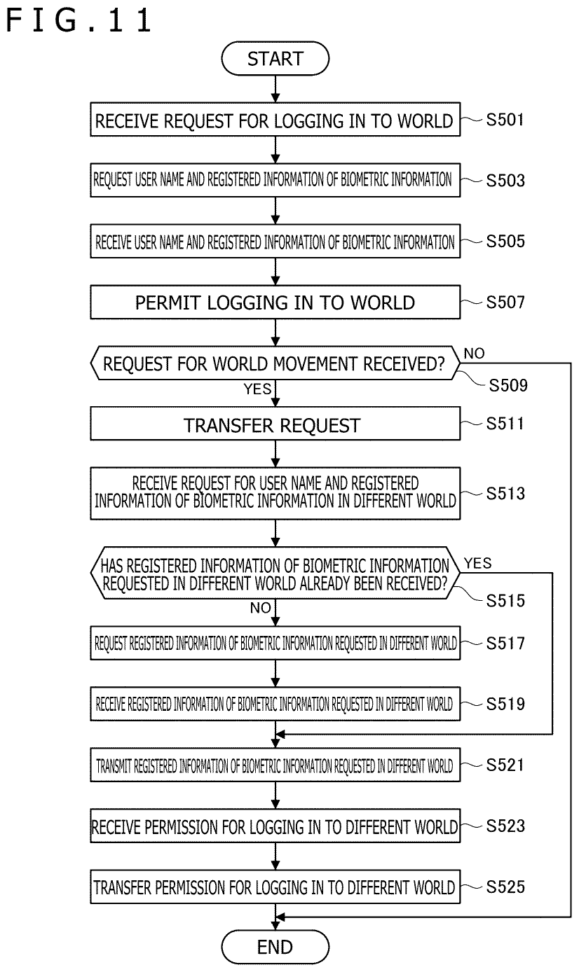

The details of the information processing system according to the present disclosure have been described above. Next, an example of the operation processing in the server 20 according to the present disclosure is described with reference to FIG. 11.

### 4. Example of Operation Processing

FIG. 11 is an explanatory diagram for explaining an example of the operation processing in the server 20 according to the present disclosure. First, the communication section 210 included in the server 20 receives log-in request information requesting logging in to the world managed by the server 20 from the edge terminal 10 (S501).

Next, the communication section 210 transmits request information requesting the user name and the registered information of the biometric information to the edge terminal 10 (S503).

Subsequently, the communication section 210 receives the user name and the registered information of the biometric information from the edge terminal 10 (S505).

Then, the permitting section 235 executes the authentication process in reference to the user name and the registered information received from the edge terminal 10 and permits the edge terminal 10 to log in to the world (S507). At this time, the communication section 210 transmits, to the edge terminal 10, permission information indicating that the edge terminal 10 is permitted to log in to the world, and the edge terminal 10 logs in to the world permitted.

Subsequently, the communication section 210 determines whether a request for world movement is received or not (S509). In a case where a request for world movement is received from the edge terminal 10 (S509: YES), the processing is advanced to S511, and in a case where a request for world movement is not received from the edge terminal 10 (S509: NO), the server 20 according to the present disclosure ends the processing.

In a case where a request for world movement is received from the edge terminal 10 (S509: YES), the communication section 210 transmits (transfers) the request to the server 20 managing the different world that is the movement destination (S511).

Further, the communication section 210 receives request information requesting the user name and the registered information of the biometric information that are requested in the different world from the server 20 that manages the different world (S513).

Next, the control section 230 determines whether the registered information of the biometric information requested in the different world has already been received or not (S515). In a case where the registered information of the biometric information requested in the different world has already been received (S515: YES), the processing is advanced to S521, and in a case where the registered information of the biometric information requested in the different world has not yet been received (S515: NO), the processing is advanced to S517.

In a case where the registered information of the biometric information requested in the different world has not yet been received (S515: NO), the communication section 210 transmits the request information requesting the registered information of the biometric information that is requested in the different world to the edge terminal 10 (S517).

Next, the communication section 210 receives the registered information of the biometric information requested in the different world from the edge terminal 10 (S519).

Thereafter, the communication section 210 transmits the registered information of the biometric information requested in the different world to the server 20 that manages the different world (S521). Here, the server 20 that manages the different world permits the edge terminal 10 to log in to the different world, in reference to the received registered information.

Next, the communication section 210 receives permission information indicating that the edge terminal 10 is permitted to log in to the different world from the server 20 that manages the different world (S523).

Then, the communication section 210 transmits (transfers) the received permission information to the edge terminal 10 (S525), and the server 20 according to the present disclosure ends the processing.

### 5. Hardware Configuration Example

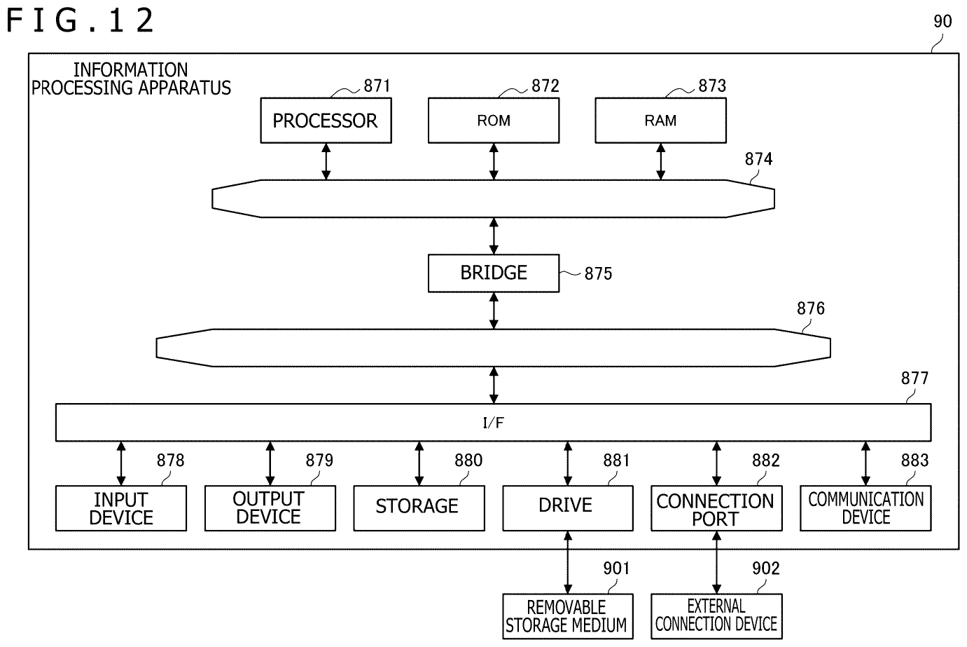

Next, a hardware configuration example of each of the edge terminal 10 and the server 20 according to one embodiment of the present disclosure is described. FIG. 12 is a block diagram illustrating a hardware configuration example of an information processing apparatus 90 according to one embodiment of the present disclosure. The information processing apparatus 90 may be a device that has a hardware configuration similar to that of the edge terminal 10 or the server 20.

As illustrated in FIG. 12, the information processing apparatus 90 includes, for example, a processor 871, a ROM 872, a RAM 873, a host bus 874, a bridge 875, an external bus 876, an interface 877, an input device 878, an output device 879, storage 880, a drive 881, a connection port 882, and a communication device 883. Note that the hardware configuration illustrated here is an example, and some of the components may be omitted. Moreover, components other than those illustrated here may further be included.

### Processor 871

The processor 871 functions, for example, as an arithmetic processing device or a control device and controls all or some of the operations of the components according to various kinds of programs recorded in the ROM 872, the RAM 873, the storage 880, or a removable storage medium 901.

### ROM 872, RAM 873

The ROM 872 is means for storing programs to be read in the processor 871, data to be used for arithmetic operation, and the like. In the RAM 873, for example, programs to be read in the processor 871, various kinds of parameters that vary as appropriate when the programs are executed, and the like are temporarily or permanently stored.

### Host Bus 874, Bridge 875, External Bus 876, Interface 877

The processor 871, the ROM 872, and the RAM 873 are, for example, connected to one another via the host but 874 capable of high speed data transfer. Meanwhile, the host bus 874 is, for example, connected to the external bus 876 that is relatively low in data transfer speed, via the bridge 875. Further, the external bus 876 is connected to various kinds of components via the interface 877.

### Input Device 878

For the input device 878, for example, a mouse, a keyboard, a touch panel, a button, a switch, a lever, and the like are used. Further, as the input device 878, a remote controller (hereinafter referred to as the remote control) that is capable of transmitting control signals with use of infrared rays and other radio waves is used in some cases. Further, the input device 878 includes an audio input device such as a microphone.

### Output Device 879

The output device 879 is a device capable of visually or aurally notifying the user of acquired information such as a display device including a CRT (Cathode Ray Tube), an LCD, or an organic EL, an audio output device including a speaker and a headphone, a printer, a mobile phone, or a facsimile machine. Further, the output device 879 according to the present disclosure includes various kinds of vibration devices capable of outputting tactile stimulation.

### Storage 880

The storage 880 is a device for storing various kinds of data. As the storage 880, for example, a magnetic storage device such as a hard disk drive (HDD), a semiconductor storage device, an optical storage device, or a magneto-optical storage device is used.

### Drive 881

The drive 881 is, for example, a device that reads information recorded in the removable storage medium 901, such as a magnetic disk, an optical disk, a magneto-optical disk, or a semiconductor memory, or writes information in the removable storage medium 901.

### Removable Storage Medium 901

The removable storage medium 901 is, for example, a DVD medium, a Blu-ray (registered trademark) medium, an HD-DVD medium, or various kinds of semiconductor storage media. Needless to say, the removable storage medium 901 may, for example, be an IC card equipped with a contactless IC chip, an electronic device, or the like.

### Connection Port 882

The connection port 882 is, for example, a port for connection with an external connection device 902, as exemplified by a USB (Universal Serial Bus) port, an IEEE1394 port, an SCSI (Small Computer System Interface), an RS-232C port, or an optical audio terminal.

### External Connection Device 902

The external connection device 902 is, for example, a printer, a portable music player, a digital camera, a digital video camera, an IC recorder, or the like.

### Communication Device 883

The communication device 883 is a communication device for connecting to the network, and is, for example, a communication card for a wired or wireless LAN, Bluetooth (registered trademark), or a WUSB (Wireless USB), a router for optical communication, a router for an ADSL (Asymmetric Digital Subscriber Line), or modems for various kinds of communication.

### 6. Supplement

While the preferred embodiment of the present disclosure has been described in detail above with reference to the attached drawings, the technical scope of the present disclosure is not limited to such an embodiment. A person having ordinary knowledge in the technical field of the present disclosure would naturally arrive at various kinds of changes or modifications within the technical scope described in the claims and understand that such changes and modifications also obviously fall within the technical scope of the present disclosure.

Further, the steps related to the processes described in the present disclosure do not necessarily have to be processed in time series according to the order described in the flowchart or the sequence diagram. For example, the steps related to the processes of each device may be processed in an order different from the described order or may be processed in parallel.

Further, the series of processes that is to be performed by each device as described in the present disclosure may be implemented by a program stored in a non-transitory computer readable storage medium. Each program is, for example, read in to the RAM at the time of being executed by the computer and is executed by a processor such as a CPU. The storage medium is, for example, a magnetic disk, an optical disk, a magneto-optical disk, a flash memory, or the like. Further, the program may be distributed over the network, for example, without the storage medium being used.

Further, the effects described in the present specification are explanatory or exemplary to the last and are not limitative. That is, the technology according to the present disclosure can offer other effects obvious to those skilled in the art from the description in the present specification, together with or in place of the abovementioned effects.

Note that the following configurations also fall within the technical scope of the present disclosure.
(1) An information processing apparatus including:
   a communication section that receives, when logging in to a virtual space is requested by a terminal used by a user, registered information that is requested in the virtual space and that includes that biometric information of the user corresponding to the virtual space is registered in the terminal; and
   a permitting section that permits the terminal to log in to the virtual space, in reference to the registered information received by the communication section.
(2) The information processing apparatus according to (1) above, in which
   the communication section transmits, when logging in to a different virtual space managed by a different apparatus from the virtual space is requested by the terminal, registered information that is requested in the different virtual space and that includes that biometric information of the user corresponding to the different virtual space is registered in the terminal to the different apparatus.
(3) The information processing apparatus according to (2) above, in which
   the communication section transmits, when the biometric information corresponding to the different virtual space has been acquired in advance, the registered information that is requested in the virtual space and that includes that the biometric information of the user corresponding to the different virtual space is included in the terminal to the different apparatus.
(4) The information processing apparatus according to (2) above or (3) above, in which
   the communication section further receives, when the biometric information corresponding to the different virtual space has not been acquired in advance, the registered information that is requested in the different virtual space and that includes that the biometric information of the user corresponding to the different virtual space is registered in the terminal to the terminal.
(5) The information processing apparatus according to any one of (2) above to (4) above, in which,
   when the logging in to the different virtual space managed by the different apparatus from the virtual space is requested by the terminal, the communication section transmits information regarding the request to the different apparatus and receives, from the different apparatus, information related to the registered information that is requested in the different virtual space.
(6) The information processing apparatus according to any one of (2) above to (4) above, further including:
   a storage section that stores information related to the registered information that is requested in the different virtual space.
(7) The information processing apparatus according to any one of (2) above to (5) above, in which
   the communication section transmits, when the terminal is permitted to log in to the virtual space by the permitting section, permission information indicating that logging in to the virtual space is permitted to the terminal.
(8) The information processing apparatus according to any one of (2) above to (5) above, in which
   the request for logging in to the different virtual space managed by the different apparatus from the virtual space is based on an action performed by the user in the virtual space.
(9) The information processing apparatus according to (8) above, in which
   the request for logging in to the different virtual space managed by the different apparatus from the virtual space is based on a list including selection candidates of multiple different virtual spaces that is displayed based on the action performed by the user in the virtual space.
(10) The information processing apparatus according to (8) above or (9) above, in which
   the request for logging in to the different virtual space managed by the different apparatus from the virtual space is based on an action performed by the user on a specific virtual object in the virtual space.
(11) The information processing apparatus according to (10) above, in which
   a type of the specific virtual object differs depending on whether or not biometric information requested in the different virtual space as a movement destination is included in the biometric information included in the registration information requested in the virtual space.
(12) The information processing apparatus according to any one of (8) above to (10) above, in which
   the request for logging in to the different virtual space managed by the different apparatus from the virtual space is based on an action performed by the user on specific content in the virtual space.
(13) The information processing apparatus according to any one of (8) above to (12) above, in which
   the request for logging in to the different virtual space managed by the different apparatus from the virtual space is based on entrance of an avatar of the user to a specific area in the virtual space.
(14) The information processing apparatus according to any one of (1) above to (13) above, in which
   the permitting section permits the terminal to log in to the virtual space, based on a false acceptance rate corresponding to the biometric information included in the registration information.
(15) The information processing apparatus according to (14) above, in which,
   when a false acceptance rate of the biometric information included in the registered information that is requested in the virtual space managed by the information processing apparatus is equal to or higher than a false acceptance rate of the biometric information included in the registered information that is requested in a pre-movement virtual space, the permitting section permits the terminal to log in to the virtual space.
(16) The information processing apparatus according to (14) above or (15) above, in which
   the communication section transmits a log-in ticket that allows logging in to a different virtual space that requests registered information of biometric information whose false acceptance rate is higher than a false acceptance rate of the biometric information requested in the virtual space, to the terminal that is permitted to log in to the virtual space by the permitting section.
(17) The information processing apparatus according to any one of (1) above to (17) above, in which
   the permitting section permits the terminal to log in to the virtual space, further in reference to behavioral information of the user.
(18) The information processing apparatus according to any one of (1) above to (17) above, in which
   the terminal includes an HMD, and
   the HMD unlocks by biometric authentication at a time when the HMD is worn by the user.
(19) An information processing method executed by a computer, including:
   receiving, when logging in to a virtual space is requested by a terminal used by a user, registered information that is requested in the virtual space and that includes that biometric information of the user corresponding to the virtual space is registered in the terminal; and
   permitting the terminal to log in to the virtual space, in reference to the registered information received.
(20) A program that causes a computer to implement:
   a communication function of receiving, when logging in to a virtual space is requested by a terminal used by a user, registered information that is requested in the virtual space and that includes that biometric information of the user corresponding to the virtual space is registered in the terminal; and
   a permitting function of permitting the terminal to log in to the virtual space, in reference to the registered information received.

### REFERENCE SIGNS LIST

10: Edge terminal
110: Communication section
120: Storage section
130: Sensor section
140: Display section
150: Control section
151: Recognition section
20: Server
210: Communication section
220: Storage section
230: Control section
231: Display information generation section
235: Permitting section

1. An information processing apparatus comprising:
a communication section that receives, when logging in to a virtual space is requested by a terminal used by a user, registered information that is requested in the virtual space and that includes that biometric information of the user corresponding to the virtual space is registered in the terminal; and
a permitting section that permits the terminal to log in to the virtual space, in reference to the registered information received by the communication section.

2. The information processing apparatus according to claim 1, wherein
the communication section transmits, when logging in to a different virtual space managed by a different apparatus from the virtual space is requested by the terminal, registered information that is requested in the different virtual space and that includes that biometric information of the user corresponding to the different virtual space is registered in the terminal to the different apparatus.

3. The information processing apparatus according to claim 2, wherein
the communication section transmits, when the biometric information corresponding to the different virtual space has been acquired in advance, the registered information that is requested in the virtual space and that includes that the biometric information of the user corresponding to the different virtual space is included in the terminal to the different apparatus.

4. The information processing apparatus according to claim 2, wherein
the communication section further receives, when the biometric information corresponding to the different virtual space has not been acquired in advance, the registered information that is requested in the different virtual space and that includes that the biometric information of the user corresponding to the different virtual space is registered in the terminal to the terminal.

5. The information processing apparatus according to claim 2, wherein,
when the logging in to the different virtual space managed by the different apparatus from the virtual space is requested by the terminal, the communication section transmits information regarding the request to the different apparatus and receives, from the different apparatus, information related to the registered information that is requested in the different virtual space.

6. The information processing apparatus according to claim 2, further comprising:
a storage section that stores information related to the registered information that is requested in the different virtual space.

7. The information processing apparatus according to claim 2, wherein
the communication section transmits, when the terminal is permitted to log in to the virtual space by the permitting section, permission information indicating that logging in to the virtual space is permitted to the terminal.

8. The information processing apparatus according to claim 2, wherein
the request for logging in to the different virtual space managed by the different apparatus from the virtual space is based on an action performed by the user in the virtual space.

9. The information processing apparatus according to claim 8, wherein
the request for logging in to the different virtual space managed by the different apparatus from the virtual space is based on a list including selection candidates of multiple different virtual spaces that is displayed based on the action performed by the user in the virtual space.

10. The information processing apparatus according to claim 8, wherein
the request for logging in to the different virtual space managed by the different apparatus from the virtual space is based on an action performed by the user on a specific virtual object in the virtual space.

11. The information processing apparatus according to claim 10, wherein
a type of the specific virtual object differs depending on whether or not biometric information requested in the different virtual space as a movement destination is included in the biometric information included in the registration information requested in the virtual space.

12. The information processing apparatus according to claim 8, wherein
the request for logging in to the different virtual space managed by the different apparatus from the virtual space is based on an action performed by the user on specific content in the virtual space.

13. The information processing apparatus according to claim 8, wherein
the request for logging in to the different virtual space managed by the different apparatus from the virtual space is based on entrance of an avatar of the user to a specific area in the virtual space.

14. The information processing apparatus according to claim 1, wherein
the permitting section permits the terminal to log in to the virtual space, based on a false acceptance rate corresponding to the biometric information included in the registration information.

15. The information processing apparatus according to claim 14, wherein,
when a false acceptance rate of the biometric information included in the registered information that is requested in the virtual space managed by the information processing apparatus is equal to or higher than a false acceptance rate of the biometric information included in the registered information that is requested in a pre-movement virtual space, the permitting section permits the terminal to log in to the virtual space.

16. The information processing apparatus according to claim 14, wherein
the communication section transmits a log-in ticket that allows logging in to a different virtual space that requests registered information of biometric information whose false acceptance rate is higher than a false acceptance rate of the biometric information requested in the virtual space, to the terminal that is permitted to log in to the virtual space by the permitting section.

17. The information processing apparatus according to claim 1, wherein
the permitting section permits the terminal to log in to the virtual space, further in reference to behavioral information of the user.

18. The information processing apparatus according to claim 1, wherein
the terminal includes an HMD, and
the HMD unlocks by biometric authentication at a time when the HMD is worn by the user.

19. An information processing method executed by a computer, comprising:
receiving, when logging in to a virtual space is requested by a terminal used by a user, registered information that is requested in the virtual space and that includes that biometric information of the user corresponding to the virtual space is registered in the terminal; and
permitting the terminal to log in to the virtual space, in reference to the registered information received.

20. A program that causes a computer to implement:
a communication function of receiving, when logging in to a virtual space is requested by a terminal used by a user, registered information that is requested in the virtual space and that includes that biometric information of the user corresponding to the virtual space is registered in the terminal; and
a permitting function of permitting the terminal to log in to the virtual space, in reference to the registered information received.
